(19) United States
(12) Patent Application Publication
(10) Pub. No.: US 2021/0183007 A1
(43) Pub. Date: Jun. 17, 2021

(54) DISPLAY HARDWARE ENHANCEMENT FOR INLINE OVERLAY CACHING

(71) Applicant: QUALCOMM Incorporated, San Diego, CA (US)

(72) Inventors: Dileep Marchya, Hyderabad (IN); Dhaval Kanubhai Patel, San Diego, CA (US); Gopikrishnaiah Andandan, San Diego, CA (US)

(21) Appl. No.: 16/714,019

(22) Filed: Dec. 13, 2019

(51) Int. Cl. G06T 1/60; G09G 5/377

(52) U.S. Cl. CPC G06T 1/60; G09G 5/377; G09G 2360/121; G09G 2340/10; G09G 2340/12

(57) ABSTRACT

Methods, systems, and devices for image processing are described. A device may determine one or more static layers of a layer stack and one or more updating layers of the layer stack. The device may determine an order of the one or more static layers, or the one or more updating layers, or both in the layer stack. In some examples, the device may modify the order in the layer stack by positioning the one or more static layers below the one or more updating layers in the layer stack. Each static layer of the one or more static layers may be associated with a first blending equation and each updating layer of the one or more updating layers may be associated with a second blending equation. As a result, the device may process the layer stack based on the modified order.

### FIELD OF TECHNOLOGY

The following relates generally to image processing and more specifically to display hardware enhancement for inline overlay caching.

### BACKGROUND

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include wireless communications systems, entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices. As demand for multimedia communication efficiency increases, some multimedia systems may fail to provide satisfactory multimedia operations for multimedia communications, and thereby may be unable to support high reliability or low latency multimedia operations, among other examples.

### SUMMARY

The described techniques relate to configuring a device to support inline overlay caching, and more specifically an inverse blending model that supports use of the inline overlay caching. The device may determine an order of one or more static layers of a layer stack. The one or more static layers may correspond to layers of the layer stack that are for caching in a cache memory of the device. Based on the determination, the device may modify the order of the one or more static layers in the layer stack by positioning (e.g., pulling-down) the one or more static layers to a lowest z-order (e.g., 0, 1, 2) of the layer stack. The device may also determine an order of one or more updating layers (also referred to as non-static layers) of the layer stack, and modify the order of the one or more updating layers by positioning the updating layers above the one or more static layers in the layer stack, and blending the layers using inverse blending. The described techniques may thus include features for improvements to power consumption, higher rendering rates and, in some examples, may promote enhanced efficiency for high reliability and low latency multimedia rendering operations in multimedia systems, among other benefits.

A method of image processing at a device is described. The method may include determining one or more static layers of a layer stack associated with an application running on the device and one or more updating layers of the layer stack, determining an order of the one or more static layers, or the one or more updating layers, or both in the layer stack, modifying the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and processing the layer stack associated with the application based on the modified order.

An apparatus for image processing is described. The apparatus may include a processor, memory coupled with the processor, and instructions stored in the memory. The instructions may be executable by the processor to cause the apparatus to determine one or more static layers of a layer stack associated with an application running on the apparatus and one or more updating layers of the layer stack, determine an order of the one or more static layers, or the one or more updating layers, or both in the layer stack, modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and process the layer stack associated with the application based on the modified order.

Another apparatus for image processing is described. The apparatus may include means for determining one or more static layers of a layer stack associated with an application running on the apparatus and one or more updating layers of the layer stack, determining an order of the one or more static layers, or the one or more updating layers, or both in the layer stack, modifying the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and processing the layer stack associated with the application based on the modified order.

A non-transitory computer-readable medium storing code for image processing at a device is described. The code may include instructions executable by a processor to determine one or more static layers of a layer stack associated with an application running on the device and one or more updating layers of the layer stack, determine an order of the one or more static layers, or the one or more updating layers, or both in the layer stack, modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and process the layer stack associated with the application based on the modified order.

In some examples of the method, apparatuses, and non-transitory computer-readable medium described herein, determining a cascade of blending stages associated with the one or more static layers, or the one or more updating layers, or both, where processing the layer stack associated with the application includes: processing, over the cascade of blending stages, the one or more static layers, or the one or more updating layers, or both according to one or more of the first blending equation or the second blending equation.

Some examples of the method, apparatuses, and non-transitory computer-readable medium described herein may further include operations, features, means, or instructions for storing the one or more static layers in a cache memory of the device, where processing the layer stack associated with the application may be based on storing the one or more static layers in the cache memory of the device.

Some examples of the method, apparatuses, and non-transitory computer-readable medium described herein may further include operations, features, means, or instructions for determining an ending static layer of the one or more static layers, determining a blending stage of a cascade of blending stages associated with the one or more static layers, or the one or more updating layers, or both, where the blending stage includes blending the ending static layer according to the first blending equation, and storing the ending static layer of the one or more static layers in a cache memory of the device based on the blending stage of the cascade of blending stages.

In some examples of the method, apparatuses, and non-transitory computer-readable medium described herein, modifying the order in the layer stack may include operations, features, means, or instructions for positioning the one or more static layers of the layer stack in a lower portion of the layer stack, and maintaining, based on positioning the one or more static layers of the layer stack in the lower portion of the layer stack, one or more blending parameters associated with the one or more static layers and the first blending equation.

In some examples of the method, apparatuses, and non-transitory computer-readable medium described herein, processing the layer stack may include operations, features, means, or instructions for processing, over one or more blending stages of a cascade of blending stages, the one or more static layers of the layer stack based on the first blending equation, where the first blending equation includes one or more blending parameters.

In some examples of the method, apparatuses, and non-transitory computer-readable medium described herein, processing the layer stack may include operations, features, means, or instructions for processing, over one or more blending stages of a cascade of blending stages, the one or more updating layers based on the second blending equation, where the second blending equation includes one or more blending parameters.

In some examples of the method, apparatuses, and non-transitory computer-readable medium described herein, the second blending equation may be an inverse blending equation of the first blending equation.

In some examples of the method, apparatuses, and non-transitory computer-readable medium described herein, processing the layer stack may include operations, features, means, or instructions for blending, over one or more blending stages of a cascade of blending stages, the one or more static layers and the one or more updating layers of the layer stack, and providing, over the one or more blending stages of the cascade of blending stages, surface data associated with the layer stack.

In some examples of the method, apparatuses, and non-transitory computer-readable medium described herein, providing the surface data may include operations, features, means, or instructions for storing the surface data at each blending stage of the cascade of blending stages in a cache memory of the device.

In some examples of the method, apparatuses, and non-transitory computer-readable medium described herein, providing the surface data may include operations, features, means, or instructions for forwarding the surface data from one blending stage to a subsequent blending stage of the cascade of blending stages.

In some examples of the method, apparatuses, and non-transitory computer-readable medium described herein, modifying the order in the layer stack may include operations, features, means, or instructions for determining a displacement of one or more updating layers of the one or more updating layers based on the modified order, inversing a position of the displaced one or more updating layers in the layer stack, and positioning the displaced one or more updating layers between the one or more static layers and one or more remaining updating layers of the one or more updating layers.

In some examples of the method, apparatuses, and non-transitory computer-readable medium described herein, processing the layer stack may include operations, features, means, or instructions for processing the one or more static layers based on the first blending equation, where the first blending equation may be associated with one or more blending parameters, processing the displaced one or more updating layers based on the second blending equation, where the second blending equation includes the one or more blending parameters and may be an inverse blending equation of the first blending equation, and processing the one or more remaining updating layers based on the first blending equation.

In some examples of the method, apparatuses, and non-transitory computer-readable medium described herein, one or more remaining updating layers of the one or more updating layers correspond to the order in the layer stack.

### BRIEF DESCRIPTION OF THE DRAWINGS

FIG. 1 illustrates an example of a multimedia system that supports display hardware enhancement for inline overlay caching in accordance with aspects of the present disclosure.

FIGS. 2 through 4 illustrate examples of blending schemes that support display hardware enhancement for inline overlay caching in accordance with aspects of the present disclosure.

FIGS. 5 and 6 show block diagrams of devices that support display hardware enhancement for inline overlay caching in accordance with aspects of the present disclosure.

FIG. 7 shows a block diagram of a multimedia manager that supports display hardware enhancement for inline overlay caching in accordance with aspects of the present disclosure.

FIGS. 8 and 9 show diagrams of systems including a device that supports display hardware enhancement for inline overlay caching in accordance with aspects of the present disclosure.

FIG. 10 shows a flowchart illustrating methods that support display hardware enhancement for inline overlay caching in accordance with aspects of the present disclosure.

### DETAILED DESCRIPTION

A device may be configured to use overlay caching schemes for rendering, via a processor (e.g., a display processor) of the device, multimedia-related content in the form of frames. A frame may be an audio frame or a video frame, or both associated with an application. In some examples, the device may refresh one or more updating layers (also referred to as non-static layers) of a layer stack associated with the application running on the device, while one or more static layers of the layer stack remain unchanged. In some examples, use of the overlay caching schemes may reduce a pixel processing load on the processor of the device, as well as decrease power consumption by the device when rendering the multimedia-related content.

In some cases, the device may blend and cache the one or more static layers in memory of the device, thereby avoiding blending the one or more static layers over multiple refresh cycles associated with rendering the multimedia-related content. Although use of the overlay caching schemes may help, some overlay caching schemes may not be feasible because blending of layers of the layer stack are performed in an ascending order (i.e., bottom-up z-order) and the one or more static layers may be positioned in the higher z-orders. As demand for multimedia operations (e.g., rendering) efficiency increases, some devices may fail to provide efficient multimedia operations, and thereby may be unable to support high reliability and low latency multimedia communications, among other examples.

To address the above shortcomings, the device may be configured to use an inverse blending model that supports use of overlay caching. For example, the device may identify the one or more static layers of the layer stack. The one or more static layers may correspond to layers of the layer stack that are for caching. Based on identifying the one or more static layers of the layer stack, the device may position (e.g., pulldown) the one or more static layers to a lowest z-order (e.g., 0, 1, 2). The device may then identify one or more updating layers of the layer stack and position the updating layers above the one or more static layers and blend using inverse blending. The device may process the remaining layers by pushing the layers to the top of the layer stack and blending the layers in their original order.

Particular aspects of the subject matter described in this disclosure may be implemented to realize one or more of the following potential advantages. The techniques employed by the described communication devices may provide benefits and enhancements to the operation of the device. For example, operations performed by the described device may provide improvements to multimedia communications, and more specifically to multimedia rendering, streaming, etc., in a multimedia system. In some examples, configuring the described device with an inverse blending model that supports use of overlay caching may support improvements to power consumption, higher rendering rates and, in some examples, may promote enhanced efficiency and low latency for multimedia operations (e.g., audio streaming, video streaming), among other benefits.

Aspects of the disclosure are initially described in the context of multimedia systems. Aspects of the disclosure are then illustrated by and described with reference to blending schemes that relate to display hardware enhancement for inline overlay caching. Aspects of the disclosure are further illustrated by and described with reference to apparatus diagrams, system diagrams, and flowcharts that relate to display hardware enhancement for inline overlay caching.

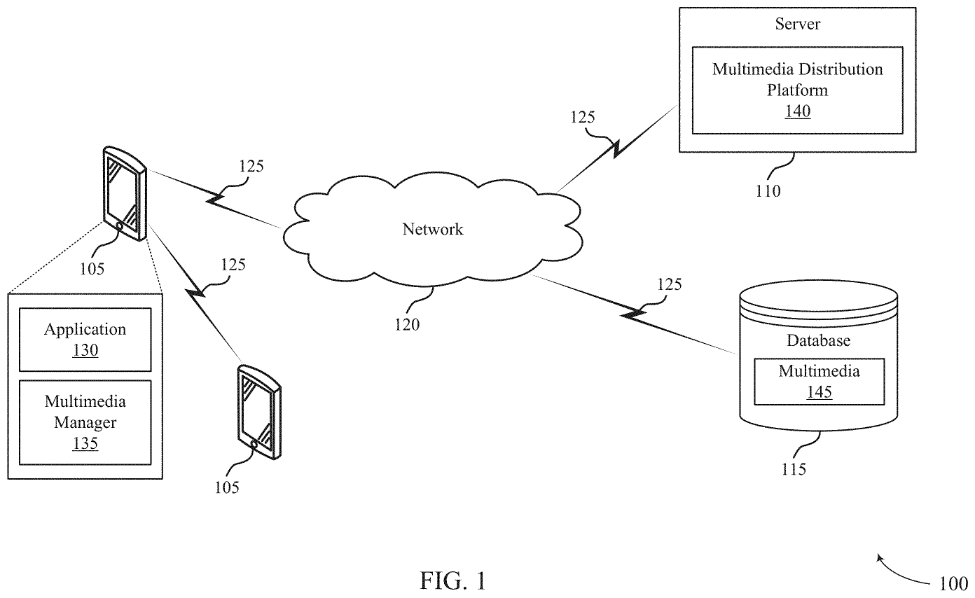

FIG. 1 illustrates an example of a multimedia system 100 that supports display hardware enhancement for inline overlay caching in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports inline overlay caching, such as multimedia packets (e.g., audio packets, voice packets, video packets), multimedia data, or multimedia control information, via network 120 using communications links 125. In some cases, a portion or all of the techniques described herein supporting inline overlay caching may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), another device, or any combination thereof that supports various types of communication and functional features related to multimedia (e.g., transmitting, receiving, broadcasting, streaming, sinking, capturing, storing, and recording multimedia data (e.g., audio packets)). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and the like. For example, the multimedia manager 135 may process multimedia (e.g., image data, video data, audio data) from and write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support inline overlay caching, according to the techniques described herein.

In some examples, a device 105 may determine one or more static layers of a layer stack associated with the application 130 running on the device 105. The device 105 may determine one or more updating layers of the layer stack. In an example, the device 105 may determine an order of the one or more static layers, the one or more updating layers, or both in the layer stack. In some examples, the device 105 may modify the order in the layer stack associated with the application 130 by positioning the one or more static layers below the one or more updating layers in the layer stack. The device 105 may process the layer stack associated with the application 130, for example, based on the modified order. In some examples, the device 105 may process the static layers based on a first blending equation and process the updating layers based on a second blending equation. The second blending equation may be, for example, an inverse blending equation of the first blending equation.

The server 110 may be a data server, a cloud server, a server associated with a multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support inline overlay caching associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking. Internet Protocol (IP) connectivity, and other access, computation, modification, and functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and downlink transmissions, from the server 110 and the database 115 to the device 105. The communication links 125 may transmit bidirectional communications and unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and other connection types related to wireless communication systems.

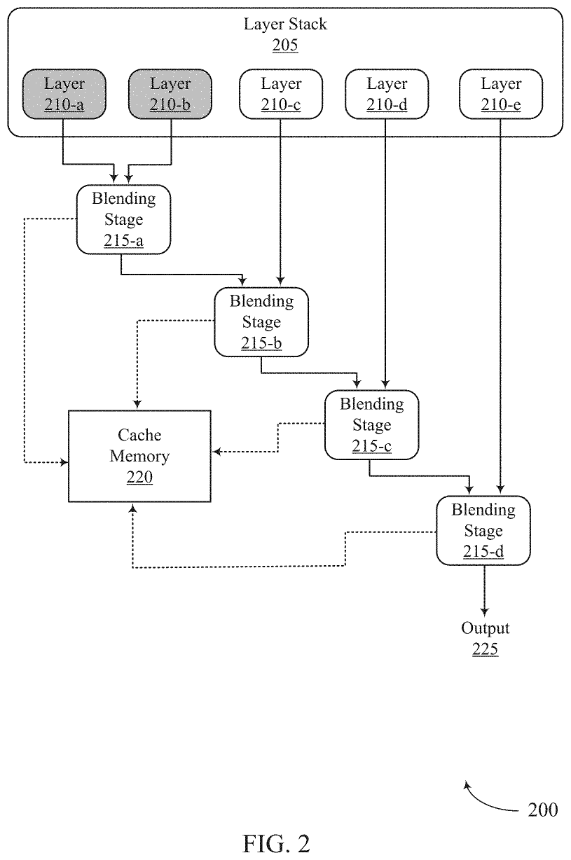

FIG. 2 illustrates an example of a blending scheme 200 that supports display hardware enhancement for inline overlay caching in accordance with aspects of the present disclosure. In some examples, the blending scheme 200 may implement aspects of the multimedia system 100. For example, the blending scheme 200 may be implemented by a device 105. In some examples, the device 105 may be configured to use a blending model or an inverse blending model, or both to process a layer stack 205 including one or more layers 210. The blending model and the inverse blending model may support use of overlay caching. In some examples, the one or more layers 210 may include one or more of static layers and updating layers, for example, such as updating layers 210-a, 210-b and static layers 210-c through 210-e.

The updating layers 210-a, 210-b may be referred to as non-static, or dynamic, layers of the layer stack 205. The updating layers 210-a and 210-b may include, for example, information (e.g., data) dynamically creatable, modifiable, or updatable by the device 105. The information (e.g., data) may include, for example, image data or video data, or both. In some examples, the updating layers 210-a, 210-b may include image data or video data, or both rendered by the device 105. The updating layers 210-a, 210-b may be associated with, for example, dynamic updating layers associated with a user interface displayed by the device 105.

The static layers 210-c through 210-c may correspond to layers of the layer stack 205 which may include information (e.g., data) reusable by, for example, the device 105. For example, as part of overlay caching, the device 105 may store information (e.g., data) included in the static layers 210-c through 210-e to a cache memory 220. The cache memory 220 may be included in the device 105 or coupled to the device 105. The cache memory 220 may be also be referred to as a level 2 (L2) memory. In some examples, the device 105 may access the information (e.g., data) associated with the static layers 210-c through 210-c, as stored in the cache memory 220, which may reduce processing load (e.g., pixel processing load) and save power in a display pipeline associated with displaying or rendering frames included in layers of the layer stack 205 (e.g., frames included in the static layers 210-c through 210-e).

In an example, the device 105 may identify one or more static layers of the layer stack 205 associated with running the application 130 on the device 105. For example, the device 105 may identify the static layers 210-c through 210-c. In some examples, the device 105 may identify one or more updating layers of the layer stack 205. For example, the device 105 may identify the updating layers 210-a, 210-b. The device 105 may determine (e.g., identify) an order of the static layers, the updating layers, or both in the layer stack 205. For example, the device 105 may determine positions (e.g., identify positions according to a z-order) of the updating layers 210-a, 210-b and the static layers 210-c through 210-e.

In some examples, the device 105 may position (e.g., modify positions of) one or more static layers of the layer stack 205 and one or more remaining layers of the layer stack 205 (e.g., according to z-order). For example, the device 105 may position one or more static layers of the layer stack 205 (e.g., according to a lowest z-order) and position one or more remaining layers of the layer stack 205 to the top of the layer stack 205 (e.g., according to a higher z-order). For example, the device 105 may position (e.g., pulldown) the static layers 210-c through 210-e to a lowest z-order (e.g., 0, 1, 2) and position (e.g., push) the updating layers 210-a, 210-b to a higher position in the layer stack 205 according to a higher z-order (e.g., 3, 4). The device 105 may position (e.g., push) the updating layers 210-a. 210-b to the higher position, for example, according to an order different than the original order of the updating layers 210-a, 210-b (e.g., according to an order opposite the original order). In some examples, the device 105 may position (e.g., push) other remaining layers in the layer stack 205 according to a higher z-order (e.g., 5, 6), for example, above the updating layers 210-a, 210-b. The remaining layers may include, for example, remaining updating layers of the layer stack 205.

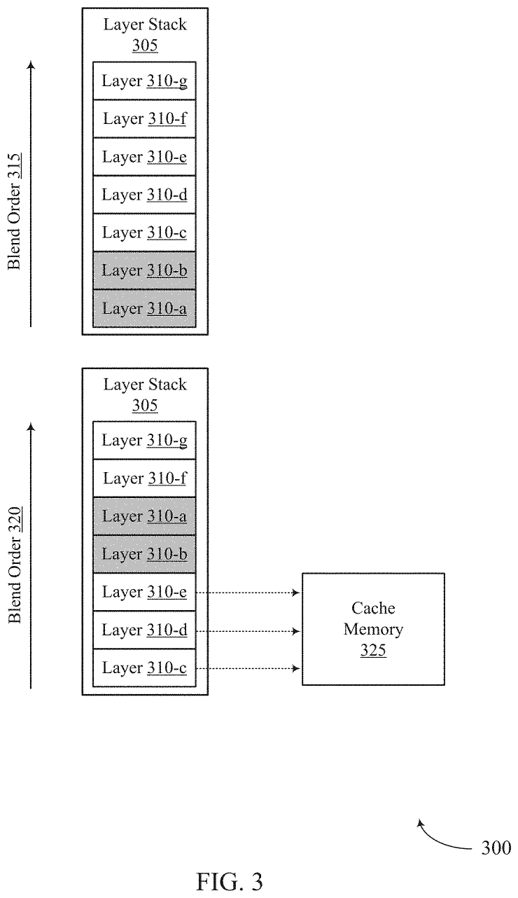

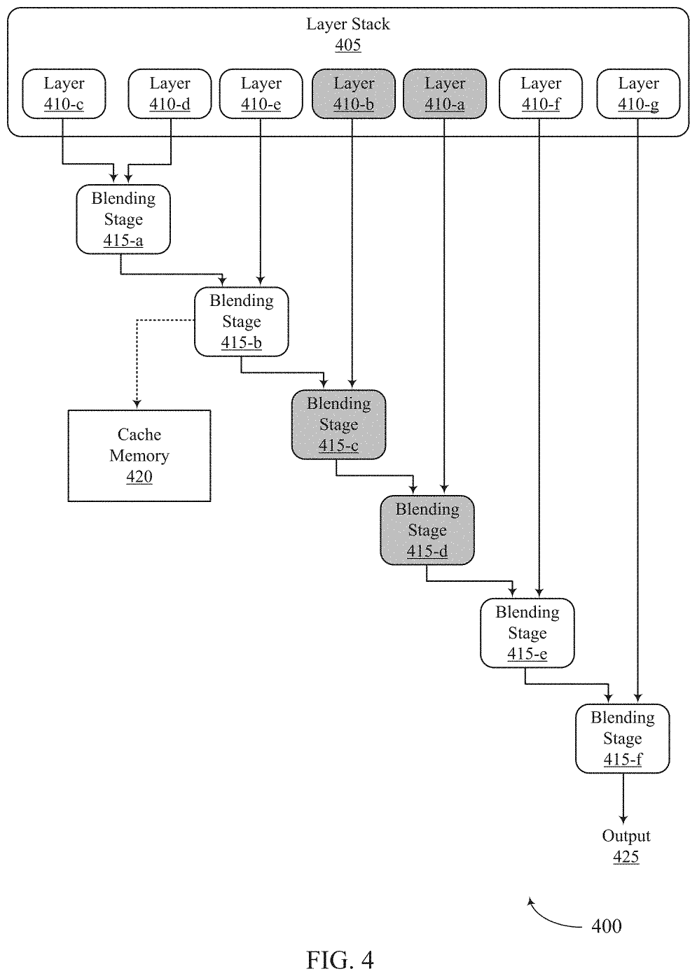

The device 105 may blend static layers and updating layers of the layer stack 205, for example, using one or more blending stages 215. The blending stages 215 may be, for example, a cascade of blending stages. In some examples, at each blending stage 215, the device 105 may blend two or more layers 210 of the layer stack 205 according to a blending equation associated with the layer 210 or the blending stage 215. Based on the positioning (e.g., repositioning, reordering) the layers 210 of the layer stack 205 described herein, for example, the device 105 may blend the static layers 210-c through 210-e based on a first blending equation, and in some examples, blend the updating layers 210-a, 210-b based on a second blending equation different than the first blending equation. In some examples, the device 105 may blend other remaining layers 210 in the layer stack 205 (e.g., blend remaining updating layers) based on the first blending equation. Examples of aspects of positioning (e.g., repositioning, reordering) the layers of the layer stack 205 (e.g., the updating layers 210-a, 210-b, the static layers 210-c through 210-e, and other remaining layers 210 of the layer stack 205) are further described herein with respect to FIGS. 3 and 4.

Examples of aspects described herein provide various improvements. For example, some devices, in processing a layer stack, may perform blending in an ascending order (i.e., bottom-up z-order) using one (e.g., the same) blending equation for blending all layers in the layer stack. Referring to FIG. 2, as an example, some devices may blend layers 210 of the layer stack 205 based on a sequential order (e.g., an original order) of the layers 210, using the blending stages 215. For example, in processing the layer stack 205, some devices may blend the layers 210-a through 210-c using blending stages 215-a through 215-d, according to a bottom-up z-order. For example, some devices may blend the layers 210-a and 210-b at a blending stage 215-a, blend the output of the blending stage 215-a and the layer 210-c at a blending stage 215-b, blend the output of the blending stage 215-b and the layer 210-d at a blending stage 215-c, and blend the output of the blending stage 215-c and the layer 210-e at a blending stage 215-d. Some devices may use one (e.g., the same) blending equation for each of the blending stages 215-a through 215-d.

In an example of pre-multiplied alpha color pixels, for example, some devices may use a display overlay model including Equations (1) and (2) for each of the blending stages 215-a through 215-d. In Equations (1) and (2), fg may correspond to a foreground pixel, and hg may represent a background pixel.

out.a=fg.a+bg.a(1−fg.a) (1)

out.rgb=fg.rgb+bg.rgb(1−fg.a) (2)

Each of the layers 210 (e.g., the layers 210-a through 210-e) may have a red value, green value, blue value, and a normalization value. In an example, the layer 210-a may have a red value, green value, blue value, and a normalization value of (20, 36, 40, 1.0). The layer 210-b may have a red value, green value, blue value, and a normalization value of (40, 36, 48, 0.9). The layer 210-c may have a red value, green value, blue value, and a normalization value of (16, 20, 24, 0.8). The layer 210-d may have a red value, green value, blue value, and a normalization value of (80, 68, 40, 0.6). The layer 210-e may have a red value, green value, blue value, and a normalization value of (80, 96, 72, 0.5).

In some examples, using a display overlay model, in blending the layers 210-a through 210-e based on an ascending order (i.e., bottom-up z-order), may output a red value, green value, blue value, and a normalization value of (42, 39.6, 52, 1) at the blending stage 215-a, output a red value, green value, blue value, and a normalization value of (24.4, 27.92, 34.4, 1) at the blending stage 215-b, output a red value, green value, blue value, and a normalization value of (89.76, 79.168, 53.76, 1) at the blending stage 215-c, and output a red value, green value, blue value, and a normalization value of (124.88, 135.58, 98.88, 1) at the blending stage 215-d (e.g., at output 225). In some examples, the output surface data of a blending stage 215 (e.g., the blending stage 215-a) may be fed to a subsequent blending stage (e.g., the blending stage 215-b) for blending with a next layer sequentially (e.g., the layer 210-c).

Static layers (e.g., the static layers 210-c through 210-e) may be blended, for example, once and cached in a cache memory (e.g., the cache memory 220). In some examples, pixels associated with the static layers (e.g., static layers 210-c through 210-c) may be blended with updating layers (e.g., the updating layers 210-a and 210-b) in the subsequent cycles. However, some devices may be unable to implement overlay caching, for example, within a display engine due to a configuration or capabilities of the display engine. Static layers may be present at higher z-orders, for example, due to more frequent content updates in updating layers present at lower z-orders. In some cases, static layers may be on top of or sandwiched between the updating layers. However, some devices may be unable to implement selected blend caching of such sandwiched or intermediate static layers.

FIG. 3 illustrates an example of a blending scheme 300 that supports display hardware enhancement for inline overlay caching in accordance with aspects of the present disclosure. In some examples, the blending scheme 300 may implement aspects of the multimedia system 100. For example, the blending scheme 300 may be implemented by a device 105. In some examples, the blending scheme 300 may include examples of aspects of the blending scheme 200 described herein.

The device 105 may determine (e.g., identify) one or more static layers of a layer stack 305 associated with an application running on the device 105. For example, the device 105 may identify static layers 310-c through 310-c. In some examples, the device 105 may identify one or more updating layers of the layer stack 305. For example, the device 105 may identify updating layers 310-a, 310-b. The layers 310 of the layer stack 305 (e.g., the updating layers 310-a, 310-b and the static layers 310-c through 310-e) may include examples of the layers 210 of the layer stack 205 (e.g., the updating layers 210-a, 210-b and the static layers 210-c through 210-e) described herein.

The device 105 may determine (e.g., identify) an order of the layers 310 of the layer stack 305. For example, the device 105 may determine (e.g., identify) an order of the static layers 310-c through 310-e, the updating layers 310-a, 310-b, or both in the layer stack 305. For example, the device 105 may determine positions (e.g., identify positions according to a z-order) of the updating layers 310-a, 310-b and the static layers 310-c through 310-c. The z-order may correspond to, for example, a blend order associated with blending the layers 310 of the layer stack 305. For example, the device 105 may determine (e.g., identify) a blend order 315 associated with one or more blending layers 310 (e.g., the updating layers 310-a, 310-b) of the layer stack 305.

In some examples, the device 105 may modify the order (e.g., the blend order 315) in the layer stack 305 associated with the application by positioning the static layers 310-c through 310-e below the updating layers 310-a, 310-b in the layer stack 305 (e.g., by positioning the static layers 310-c through 310-e and the updating layers 310-a, 310-b in the layer stack 305 according to a blend order 320 different than the blend order 315). In some examples, the device 105 may position the updating layers 310-a, 310-b according to an inverse order (e.g., such that the updating layer 310-b is below the updating layer 310-a according to a z-order). Each of the static layers 310-c through 310-e may be associated with a first blending equation, and each of the updating layers 310-a, 310-b may be associated with a second blending equation different than the first blending equation. In some examples, the second blending equation may be an inverse blending equation of the first blending equation. In some examples, the device 105 may apply blending models to the layers 310 based on a layer type (e.g., static layer, updating layer) associated with the layers 310.

The device 105 may process the layer stack 305 associated with the application based on the modified order (e.g., based on the blend order 320). In some examples, the device 105 may process the layer stack 305 based on the first and second blending equations. For example, the device 105 may process the updating layers 310-a, 310-b using the second blending equation (e.g., based on blending models associated with the second blending equation) and process the static layers 310-c through 310-c using the first blending equation (e.g., based on blending models associated with the first blending equation).

The device 105 may store data associated with the static layers 310-c through 310-e in a cache memory 325 of the device 105. In some examples, the device 105 may process the layer stack 305 based on storing and accessing the static layers 310-c through 310-c in the cache memory 325. The cache memory 325 may include examples of aspects of the cache memory 220 described herein. In some examples, the device 105 may program a concurrent write to a memory (e.g., the cache memory 325) at a blending stage where a last layer of a cache batch is blended by the device 105.

In some examples, the device 105 may pulldown layers identified for caching, from among the layers of a layer stack, while maintaining blending parameters (e.g., maintain original blending parameters) for the identified layers. For example, the device 105 may pull down static layers identified for caching, to the bottom of the layer stack, while maintaining blending parameters (e.g., maintaining original blending parameters) for the static layers. In an example of a layer stack including static layers m, m+1, m+2 . . . m+r, where m and r are integers, the device 105 may position (e.g., pulldown) the static layers m through m+r at z-orders 0, 1, 2, . . . r, while maintaining original blending parameters for the layers m through m+r. In an example, referring to the blend order 320 of FIG. 3, the device 105 may position (e.g., pulldown) the static layers 310-c through 310-c to a lowest z-order (e.g., 0, 1, 2), for example, and maintain blending parameters associated with the static layers 310-c through 310-e.

In some examples, the device 105 may reposition layers of the layer stack which are displaced by the layers identified for caching (e.g., displaced by the static layers pulled down to the bottom of the layer stack). For example, the device 105 may push updating layers (displaced by the static layers) to a position above (e.g., on top of) the static layers, in an order opposite an original layer order associated with the updating layers. In some examples, the device 105 may change the blending parameters for the updating layers to inverse blending. In an example of a layer stack including updating layers 0, 1, 2, . . . m−1, the device 105 may position the updating layers 0, 1, 2, . . . m−1 at z-orders r+m . . . r+3, r+2, r+1 (where m and r are integers), while changing blending parameters for the layers 0, 1, 2, . . . m−1 to inverse blending (e.g., change blending type to an inverse blend compared to a blending type associated with the updating layers prior to the repositioning. In an example, referring to the blend order 320 of FIG. 3, the device 105 may position (e.g., push) the updating layers 310-a, 310-b to a position above (e.g., on top of) the static layers 310-c through 310-e, for example, and change the blending parameters associated with the updating layers 310-a, 310-b to inverse blending (e.g., inverse blending compared to blending associated with the updating layers 310-a and 310-b prior to the repositioning).

In some examples, the device 105 may push remaining updating layers of the layer stack on top of the repositioned updating layers, based on a layer order (e.g., an original layer order) of the remaining updating layers prior to the repositioning of the static layers and the updating layers. The device 105 may, for example, maintain blending parameters (e.g., maintain original blending parameters) for the remaining updating layers. In an example of a layer stack including remaining updating layers m+r+1, m+r+2, . . . n, the device 105 may position the remaining updating layers m+r+1, m+r+2, . . . n at z-orders r+m+1, r+m+2, . . . n (where m, r, and n are integers), while maintaining blending parameters (e.g., maintaining original blending parameters) for the remaining updating layers m+r+1, m+r+2, . . . n. In an example, referring to the blend order 320 of FIG. 3, the device 105 may position (e.g., push) remaining updating layers of the layer stack 305 (e.g., layers 310-f and 310-g) to a position above the updating layers 310-a and 310-b (e.g., on top of the updating layer 310-a), for example, and maintaining blending parameters (e.g., maintaining original blending parameters) for the remaining updating layers of the layer stack.

FIG. 4 illustrates an example of a blending scheme 400 that supports display hardware enhancement for inline overlay caching in accordance with aspects of the present disclosure. In some examples, the blending scheme 400 may implement aspects of the multimedia system 100. For example, the blending scheme 400 may be implemented by a device 105. In some examples, the blending scheme 400 may include examples of aspects of the blending schemes 200 and 300 described herein. For example, a layer stack 405 may include aspects described herein with respect to the layer stacks 205 and 305.

The blending scheme 400 illustrates an example of a display overlay model for caching, for example, based on a modification to the layer order of the layer stack 405 by the device 105. According to examples of aspects of the blending scheme 400 described herein, the device 105 may be configured to use both a blending model and an inverse blending model to process one or more layers 410 included in the layer stack 405. The one or more layers 410 may include a combination of static layers and updating layers, for example, updating layers 410-a, 410-b, static layers 410-c through 410-c, and updating layers 410-f, 410-g.

In the example layer stack 405 illustrated in FIG. 4, the device 105 may position the static layers 410-c through 410-c below the updating layers 410-a and 410-b (e.g., according to z-order). The updating layers 410-a and 410-b may be positioned according to an order different than the original order of the updating layers 410-a and 410-b (e.g., according to an order opposite the original order). The device 105 may position remaining layers 410 of the layer stack 405 (e.g., remaining updating layers 410-f and 410-g) at the top of the layer stack 405, above the updating layers 410-a and 410-b (e.g., on top of the updating layer 410-a).

In some examples, the device 105 may blend static layers and updating layers of the layer stack 405, for example, using one or more blending stages 415. The blending stages 415 may be, for example, a cascade of blending stages. In some examples, at each blending stage 415, the device 105 may blend two or more layers 410 of the layer stack 405 according to a blending equation associated with the layer 410 or the blending stage 415.

In processing the layer stack 405 using the blending scheme 400, the device 105 may perform blending based on the modification to the layer order (i.e., modified z-order). As an example, the device 105 may blend layers 410 of the layer stack 405 based on the modified order of the layers 410, using blending stages 415. For example, in processing the layer stack 405, the device 105 may blend the layers 410-a through 410-g using blending stages 415-a through 415-f, according to the modified z-order. In some examples, the device 105 may forward surface data from a blending stage 415 to a subsequent blending stage 415. For example, the device 105 may blend the static layers 410-c and 410-d at a blending stage 415-a, blend the output of the blending stage 415-a and the static layer 410-e at a blending stage 415-b, blend the output of the blending stage 415-b and the updating layer 410-b at a blending stage 415-c, blend the output of the blending stage 415-c and the updating layer 410-a at a blending stage 415-d, blend the output of the blending stage 415-d and the updating layer 410-f (a remaining updating layer) at a blending stage 415-e, and blend the output of the blending stage 415-e and the updating layer 410-g (a remaining updating layer) at a blending stage 415-f.

In some examples, the device 105 may blend the static layers 410-c through 410-e based on a first blending equation, blend the updating layers 410-a and 410-b based on a second blending equation different than the first blending equation (e.g., based on an inverse blending equation of the first blending equation), and blend remaining layers in the layer stack 405 (e.g., blend remaining updating layers 410-f and 410-g) based on the first blending equation. In some examples, the device 105 may program the layers 410 of the layer stack 405 (e.g., position the layers 410 of the layer stack 405) and program corresponding blending parameters on each associated blending stage 415.

The device 105 may store data associated with one or more of the layers 410 of the layer stack 405 in a cache memory 420 of the device 105. In some examples, the device 105 may process the layer stack 405 based on storing and accessing the stored data or the stored layers 410. In some examples, the device 105 may provide surface data associated with the layer stack 405, over one or more of the blending stages 415. In some examples, the device 105 may store the surface data at each of the blending stages 415 in the cache memory 420 of the device 105. For example, at the blending stage 415-b, the device 105 may output data associated with the static layers 410-c through 410-c to the cache memory 420. The cache memory 420 may include examples of aspects of the cache memory 220 and cache memory 325 described herein.

In some examples, the device 105 may determine an ending static layer (e.g., the static layer 410-e) of the static layers 410-c through 410-e. The device 105 may determine a blending stage 415 (e.g., the blending stage 415-b) of the cascade of blending stages (e.g., the blending stages 415-a and 415-b) associated with the static layers 410-c through 410-c, or the updating layers 410-a and 410-b, or both, where the blending stage 415 (e.g., the blending stage 415-b) includes blending the ending static layer (e.g., the static layer 410-e) according to the first blending equation. In some examples, the device 105 may store the ending static layer (e.g., the static layer 410-e) in the cache memory 420 of the device 105 based on the blending stage 415 (e.g., the blending stage 415-b).

In an example of pre-multiplied alpha color pixels, for example, the device 105 may use a display overlay model including Equations (1) and (2) described herein for each of the blending stages 415-a, 415-b, 415-e, and 415-f. In an example of an inverse blend, and pre-multiplied alpha color pixels, for example, the device 105 may use a display overlay model including Equations (3) and (4) described herein for each of the blending stages 415-c and 415-d. In Equations (3) and (4), fg may correspond to a foreground pixel, and bg may represent a background pixel.

out.a=bg.a+fg.a(1−bg.a) (3)

out.rgb=bg.rgb+fg.rgb(1−bg.a) (4)

In some examples, for example, the inverse blend (e.g., of Equations (3) and (4)) may be based on Equations (5) and (6).

Output Color=Bα×Bc+Fα×Fc×(1−Bα) (5)

Output Alpha=Bα+Fα×(1−Bα) (6)

In some examples, for example, for premultiplied alpha color pixels, the inverse blend (e.g., of Equations (3) and (4)) may be based on Equations (7) and (8).

Output Color=Bc+Fc×(1−Bα) (7)

Output Alpha=Ba+Fα×(1−Bα) (8)

In Equations (5) through (8), for example. Fc may refer to a foreground pixel color, Bc may refer to a background pixel color, Fa may refer to a foreground pixel alpha, and Bα may refer to a background pixel alpha. Each of the layers 410 (e.g., the layers 410-a through 410-g) may have a red value, green value, blue value, and a normalization value. In an example, the layer 410-a may have a red value, green value, blue value, and a normalization value of (20, 36, 40, 1.0). The layer 410-b may have a red value, green value, blue value, and a normalization value of (40, 36, 48, 0.9). The layer 410-c may have a red value, green value, blue value, and a normalization value of (16, 20, 24, 0.8). The laver 410-d may have a red value, green value, blue value, and a normalization value of (80, 68, 40, 0.6). The layer 410-e may have a red value, green value, blue value, and a normalization value of (80, 96, 72, 0.5). The layer 410-f may have a red value, green value, blue value, and a normalization value of (50, 28, 64, 0.4). The layer 410-g may have a red value, green value, blue value, and a normalization value of (60, 54, 18, 0.3).

In an example of blending the layers 410-a through 410-g based on a modified order (i.e., z-order), the device 105 may output a red value, green value, blue value, and a normalization value of (86.4, 76, 49.6, 0.92) at the blending stage 415-a, output a red value, green value, blue value, and a normalization value of (123.2, 134, 96.8, 0.96) at the blending stage 415-b, output a red value, green value, blue value, and a normalization value of (124.8, 135.44, 98.72, 0.97) at the blending stage 415-c (e.g., inverse blend), output a red value, green value, blue value, and a normalization value of (124.88, 135.58, 98.88, 1) at the blending stage 415-d (e.g., inverse blend), output a red value, green value, blue value, and a normalization value of (124.93, 109.35, 123.33, 1) at the blending stage 415-e, and output a red value, green value, blue value, and a normalization value of (147.45, 130.55, 104.33, 1) at the blending stage 415-f (e.g., at output 425). In some examples, for example, the device 105 may feed the output surface data of a blending stage 415 (e.g., the blending stage 415-a) to a subsequent blending stage (e.g., the blending stage 415-b) for blending with a layer associated with the subsequent blending stage (e.g., the static layer 410-e).

In some examples, the techniques described herein may support a concurrent write to memory of output surface data at all blending stages, for example, in a mutual exclusion mode. For example, the device 105 may be configured (e.g., configured by software encoded on a memory of the device 105) to write the output of a blending stage 415 to memory in a given refresh cycle (e.g., a refresh cycle associated with refreshing one or more updating layers in the layer stack 405). In some examples, the techniques may support applying an inverse blending equation at all blending stages 415 (e.g., configured by software encoded on a memory of the device 105).

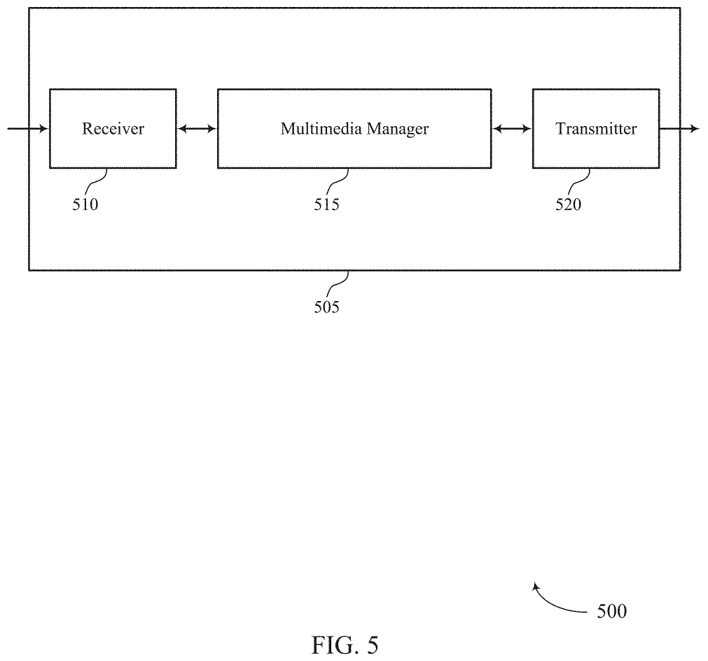

FIG. 5 shows a block diagram 500 of a device 505 that supports display hardware enhancement for inline overlay caching in accordance with aspects of the present disclosure. The device 505 may be an example of aspects of a device as described herein. The device 505 may include a receiver 510, a multimedia manager 515, and a transmitter 520. The device 505 may also include a processor. Each of these components may be in communication with one another (e.g., via one or more buses).

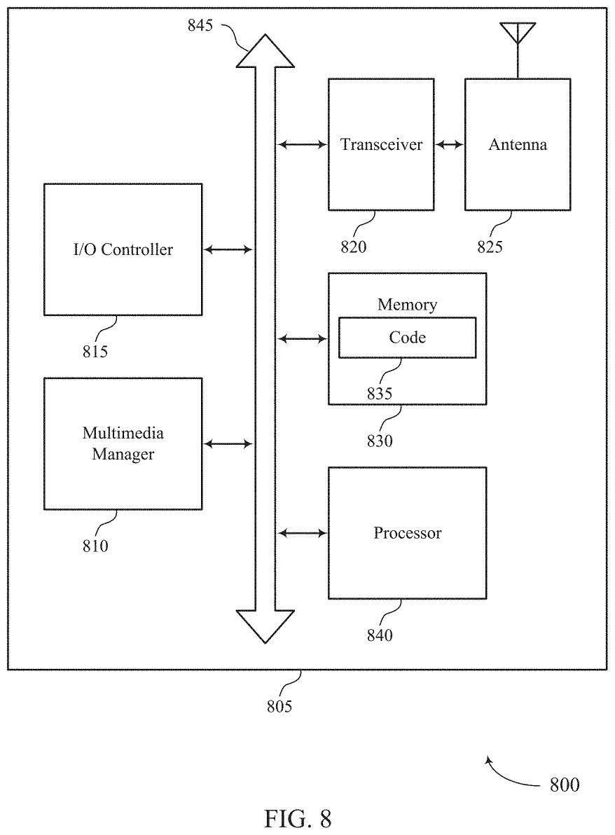

The receiver 510 may receive information such as packets, user data, or control information associated with various information channels (e.g., control channels, data channels, and information related to display hardware enhancement for inline overlay caching, etc.). Information may be passed on to other components of the device 505. The receiver 510 may be an example of aspects of the transceiver 820 described with reference to FIG. 8. The receiver 510 may utilize a single antenna or a set of antennas.

The multimedia manager 515 may determine one or more static layers of a layer stack associated with an application running on the device and one or more updating layers of the layer stack, determine an order of the one or more static layers, or the one or more updating layers, or both in the layer stack, modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and process the layer stack associated with the application based on the modified order. The multimedia manager 515 may be an example of aspects of the multimedia manager 810 described herein.

The multimedia manager 515, or its sub-components, may be implemented in hardware, code (e.g., software or firmware) executed by a processor, or any combination thereof. If implemented in code executed by a processor, the functions of the multimedia manager 515, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The multimedia manager 515, or its sub-components, may be physically located at various positions, including being distributed such that portions of functions are implemented at different physical locations by one or more physical components. In some examples, the multimedia manager 515, or its sub-components, may be a separate and distinct component in accordance with various aspects of the present disclosure. In some examples, the multimedia manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver component. For example, the transmitter 520 may be an example of aspects of the transceiver 820 described with reference to FIG. 8. The transmitter 520 may utilize a single antenna or a set of antennas.

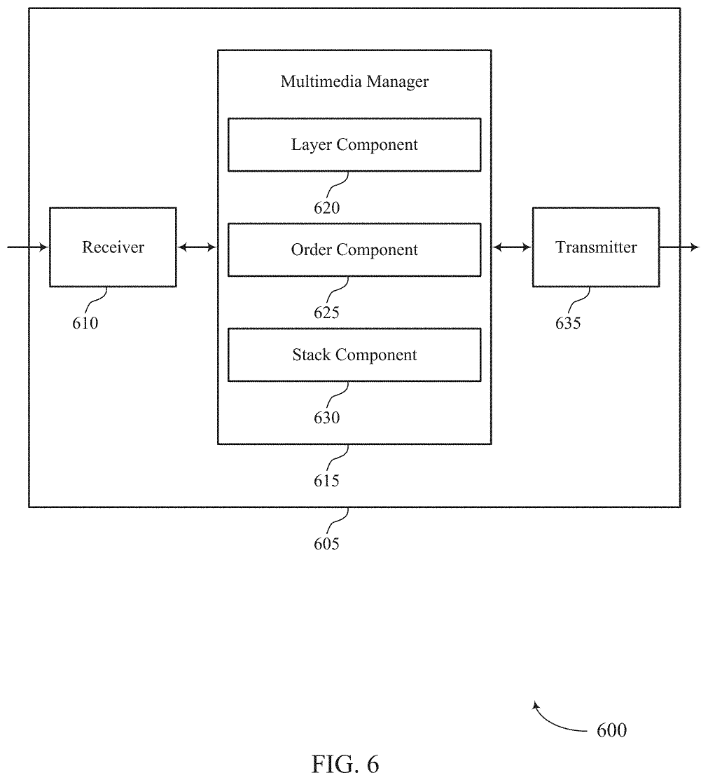

FIG. 6 shows a block diagram 600 of a device 605 that supports display hardware enhancement for inline overlay caching in accordance with aspects of the present disclosure. The device 605 may be an example of aspects of a device 505 or a device 115 as described herein. The device 605 may include a receiver 610, a multimedia manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to display hardware enhancement for inline overlay caching, etc.). Information may be passed on to other components of the device 605. The receiver 610 may be an example of aspects of the transceiver 820 described with reference to FIG. 8. The receiver 610 may utilize a single antenna or a set of antennas.

The multimedia manager 615 may be an example of aspects of the multimedia manager 515 as described herein. The multimedia manager 615 may include a layer component 620, an order component 625, and a stack component 630. The multimedia manager 615 may be an example of aspects of the multimedia manager 810 described herein.

The layer component 620 may determine one or more static layers of a layer stack associated with an application running on the device and one or more updating layers of the layer stack. The order component 625 may determine an order of the one or more static layers, or the one or more updating layers, or both in the layer stack and modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation. The stack component 630 may process the layer stack associated with the application based on the modified order.

The transmitter 635 may transmit signals generated by other components of the device 605. In some examples, the transmitter 635 may be collocated with a receiver 610 in a transceiver component. For example, the transmitter 635 may be an example of aspects of the transceiver 820 described with reference to FIG. 8. The transmitter 635 may utilize a single antenna or a set of antennas.

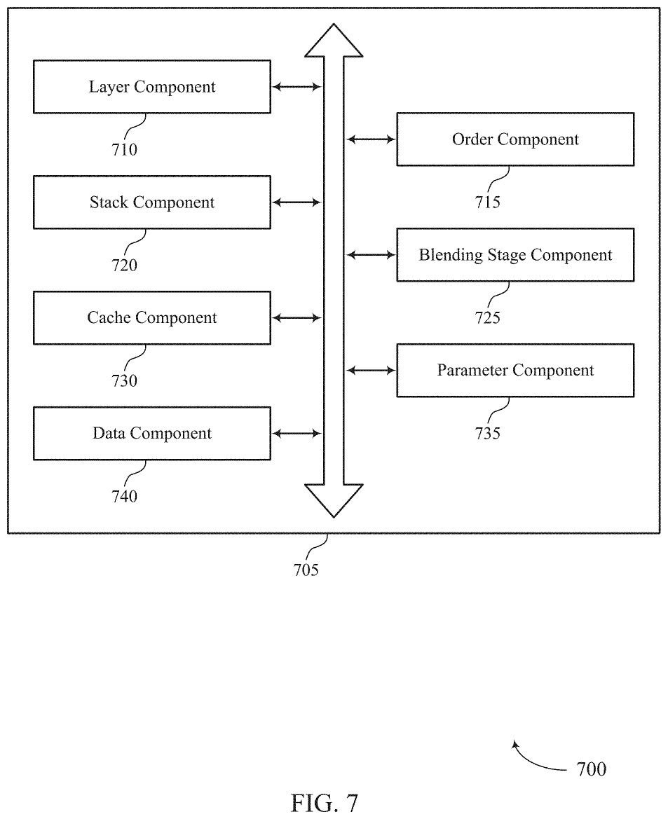

FIG. 7 shows a block diagram 700 of a multimedia manager 705 that supports display hardware enhancement for inline overlay caching in accordance with aspects of the present disclosure. The multimedia manager 705 may be an example of aspects of a multimedia manager 515, a multimedia manager 615, or a multimedia manager 810 described herein. The multimedia manager 705 may include a layer component 710, an order component 715, a stack component 720, a blending stage component 725, a cache component 730, a parameter component 735, and a data component 740. Each of these components may communicate, directly or indirectly, with one another (e.g., via one or more buses).

The layer component 710 may determine one or more static layers of a layer stack associated with an application running on the device and one or more updating layers of the layer stack. In some examples, the layer component 710 may determine an ending static layer of the one or more static layers.

The order component 715 may determine an order of the one or more static layers, or the one or more updating layers, or both in the layer stack. In some examples, the order component 715 may modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation.

In some examples, the order component 715 may position the one or more static layers of the layer stack in a lower portion of the layer stack. In some examples, the order component 715 may determine a displacement of one or more updating layers of the one or more updating layers based on the modified order. In some examples, the order component 715 may invers a position of the displaced one or more updating layers in the layer stack. In some examples, the order component 715 may position the displaced one or more updating layers between the one or more static layers and one or more remaining updating layers of the one or more updating layers.

The stack component 720 may process the layer stack associated with the application based on the modified order. In some examples, the stack component 720 may process the one or more static layers based on the first blending equation, where the first blending equation is associated with one or more blending parameters. In some examples, the stack component 720 may process the displaced one or more updating layers based on the second blending equation, where the second blending equation includes the one or more blending parameters and is an inverse blending equation of the first blending equation. In some examples, the stack component 720 may process the one or more remaining updating layers based on the first blending equation. In some cases, one or more remaining updating layers of the one or more updating layers correspond to the order in the layer stack.

The blending stage component 725 may determine a blending stage of a cascade of blending stages associated with the one or more static layers, or the one or more updating layers, or both, where the blending stage includes blending the ending static layer according to the first blending equation.

In some examples, the blending stage component 725 may process, over one or more blending stages of a cascade of blending stages, the one or more static layers of the layer stack based on the first blending equation, where the first blending equation includes one or more blending parameters. In some examples, the blending stage component 725 may process, over one or more blending stages of a cascade of blending stages, the one or more updating layers based on the second blending equation, where the second blending equation includes one or more blending parameters.

In some examples, the blending stage component 725 may blend, over one or more blending stages of a cascade of blending stages, the one or more static layers and the one or more updating layers of the layer stack. In some cases, the blending stage component 725 may determine a cascade of blending stages associated with the one or more static layers, or the one or more updating layers, or both, where processing the layer stack associated with the application includes: processing, over the cascade of blending stages, the one or more static layers, or the one or more updating layers, or both according to one or more of the first blending equation or the second blending equation. In some cases, the second blending equation is an inverse blending equation of the first blending equation.

The cache component 730 may store the one or more static layers in a cache memory of the device, where processing the layer stack associated with the application is based on storing the one or more static layers in the cache memory of the device. In some examples, the cache component 730 may store the ending static layer of the one or more static layers in a cache memory of the device based on the blending stage of the cascade of blending stages. The parameter component 735 may maintain, based on positioning the one or more static layers of the layer stack in the lower portion of the layer stack, one or more blending parameters associated with the one or more static layers and the first blending equation.

The data component 740 may provide, over the one or more blending stages of the cascade of blending stages, surface data associated with the layer stack. In some examples, the data component 740 may store the surface data at each blending stage of the cascade of blending stages in a cache memory of the device. In some examples, the data component 740 may forward the surface data from one blending stage to a subsequent blending stage of the cascade of blending stages.

FIG. 8 shows a diagram of a system 800 including a device 805 that supports display hardware enhancement for inline overlay caching in accordance with aspects of the present disclosure. The device 805 may be an example of or include the components of device 505, device 605, or a device as described herein. The device 805 may include components for bi-directional multimedia communications including components for transmitting and receiving multimedia communications, including a multimedia manager 810, an I/O controller 815, a transceiver 820, an antenna 825, memory 830, a processor 840, and a coding manager 850. These components may be in electronic communication via one or more buses (e.g., bus 845).

The multimedia manager 810 may determine one or more static layers of a layer stack associated with an application running on the device 805 and one or more updating layers of the layer stack, determine an order of the one or more static layers, or the one or more updating layers, or both in the layer stack, modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation, and process the layer stack associated with the application based on the modified order. As detailed above, the multimedia manager 810 and one or more components of the multimedia manager 810 may perform and be a means for performing, either alone or in combination with other elements, one or more operations for supporting display hardware enhancement for inline overlay caching.

The I/O controller 815 may manage input and output signals for the device 805. The/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the device 805 may include a single antenna 825. However, in some cases the device 805 may have more than one antenna 825, which may be capable of concurrently transmitting or receiving multiple wireless transmissions.

The memory 830 may include random access memory (RAM) and read-only memory (ROM). The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting display hardware enhancement for inline overlay caching).

The code 835 may include instructions to implement aspects of the present disclosure, including instructions to support image processing. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

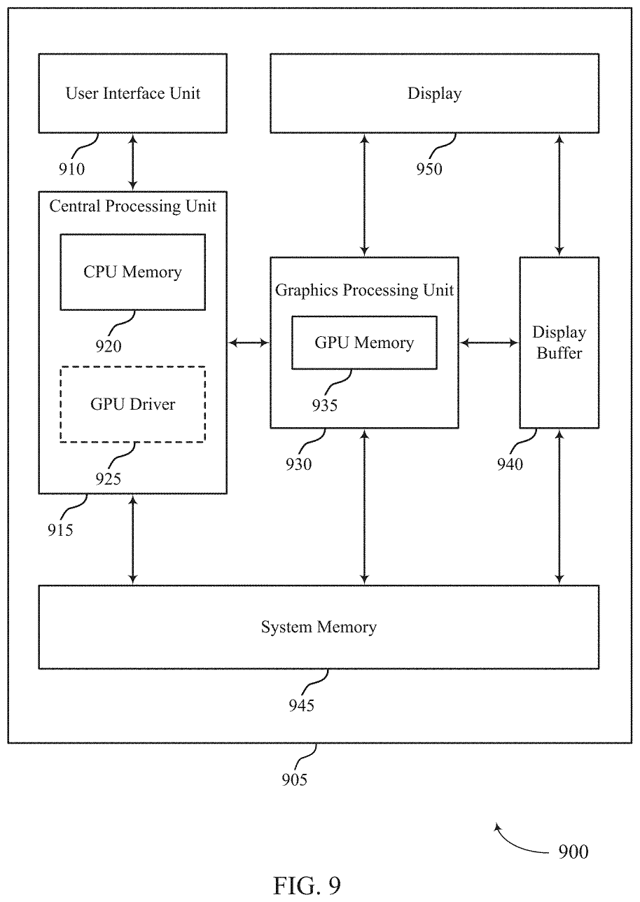

FIG. 9 shows a diagram of a system 900 including a device 905 that supports display hardware enhancement for inline overlay caching in accordance with aspects of the present disclosure. The device 905 may be an example of or include the components of device 105, device 505, device 605, device 805 or a device as described herein. The device 905 may include components for bi-directional audio and video communications including components for transmitting and receiving audio and video communications, including a user interface unit 910, a central processing unit (CPU) 915, a CPU memory 920, a graphics processing unit (GPU) driver 925, a GPU 930, a GPU memory 935, a display buffer 940, a system memory 945, and a display 950. These components may be in electronic communication via one or more buses.

The CPU 915 may include, but is not limited to, a digital signal processor (DSP), general purpose microprocessor, an ASIC, an FPGA, or other equivalent integrated or discrete logic circuitry. Although the CPU 915 and the GPU 930 are illustrated as separate units in the example of FIG. 9, in some examples, the CPU 915 and the GPU 930 may be integrated into a single unit. The CPU 915 may execute one or more software applications. Examples of the software applications may include operating systems, word processors, web browsers, e-mail applications, spreadsheets, video games, audio and video capture applications, playback or editing applications, or other such applications that initiate generation of multimedia data (e.g., audio data, video data, or a combination thereof) to be outputted via the display 950.

The CPU 915 may include the CPU memory 920. For example, the CPU memory 920 may represent on-chip storage or memory used in executing machine or object code. The CPU memory 920 may include one or more volatile or non-volatile memories or storage devices, such as flash memory, a magnetic data media, an optical storage media, etc. The CPU 915 may be configured to read values from or write values to the CPU memory 920 more quickly than reading values from or writing values to the system memory 945, which may be accessed, e.g., over a system bus. In some examples, the CPU memory 920 may be a cache memory.

The GPU 930 may represent one or more dedicated processors for performing graphical operations. For example, the GPU 930 may be a dedicated hardware unit having fixed function and programmable components for rendering graphics and executing GPU applications. The GPU 930 may also include a DSP, a general purpose microprocessor, an ASIC, an FPGA, or other equivalent integrated or discrete logic circuitry. The GPU 930 may be built with a highly-parallel structure that provides more efficient processing of complex graphic-related operations than the CPU 915. For example, the GPU 930 may include a number of processing elements that are configured to operate on multiple vertices or pixels in a parallel manner. The highly parallel nature of the GPU 930 may allow the GPU 930 to generate graphic images (e.g., graphical user interfaces and two-dimensional or three-dimensional graphics scenes) for output at the display 950 more quickly than the CPU 915.

The GPU 930 may, in some examples, be integrated into a motherboard of the device 905. In other examples, the GPU 930 may be present on a graphics card that is installed in a port in the motherboard of the device 905 or may be otherwise incorporated within a peripheral device configured to interoperate with the device 905. The GPU 930 may include the GPU memory 935. For example, the GPU memory 935 may represent on-chip storage or memory used in executing machine or object code. The GPU memory 935 may include one or more volatile or non-volatile memories or storage devices, such as flash memory, a magnetic data media, an optical storage media, etc. The GPU 930 may be able to read values from or write values to the GPU memory 935 more quickly than reading values from or writing values to the system memory 945, which may be accessed, e.g., over a system bus. That is, the GPU 930 may read data from and write data to the GPU memory 935 without using the system bus to access off-chip memory. This operation may allow the GPU 930 to operate in a more efficient manner by reducing the need for the GPU 930 to read and write data via the system bus, which may experience heavy bus traffic. In some examples, the GPU memory 935 may be a cache memory.

The device 905 may be configured to use overlay caching schemes for rendering, via a processor (e.g., the GPU 930) of the device 905, content (e.g., frames) associated with an application. According to overlay caching schemes, the device 905 may update a subset of layers of a layer stack, while the remaining subset of layers remain static. Use of the overlay caching schemes may reduce a pixel processing load on the processor (e.g., the GPU 930), as well as decrease power consumption when rendering content (e.g., frames). In some examples, the device 905 may blend and cache the static layers once in memory (e.g., the GPU memory 935), thereby avoiding blending the static layers over each refresh cycle. In some cases, while use of overlay caching schemes by the device 905 may help, some overlay caching schemes may not be feasible because blending of layers of the layer stack are performed in an ascending order (i.e., bottom-up z-order) and the static layers are generally found in the higher z-orders. To address this shortcoming, the device 905 may be configured to use an inverse blending model that supports use of overlay caching.

For example, the device 905 may identify one or more static layers of a layer stack. The one or more static layers may correspond to layers of the layer stack that are for caching. Based on identifying the one or more static layers of the layer stack, the device 905 may position (e.g., pulldown) the one or more static layers to a lowest z-order (e.g., 0, 1, 2). The device 905 may then identify one or more non-static layers of the layer stack and position the non-static layers above the one or more static layers and blend using inverse blending. The device 905 may process the remaining layers by pushing the layers to the top of the layer stack and blending the layers in their original order. In some examples, one or more of the static layers of the layer stack or the non-static layers of the layer stack may be processed, stored, configured, modified via a processor (e.g., the GPU 930) of the device 905.

The display 950 may be configured as a unit capable of displaying video, images, text or any other type of data for consumption by a viewer. The display 950 may include a liquid-crystal display (LCD), a light emitting diode (LED) display, an organic LED (OLED), an active-matrix OLED (AMOLED), or the like. The display buffer 940 may be configured as a memory or storage device dedicated to storing data for presentation of imagery, such as computer-generated graphics, still images, video frames, or the like for the display 950. The display buffer 940 may represent a two-dimensional buffer that includes a plurality of storage locations. The number of storage locations within the display buffer 940 may, in some examples, correspond to the number of pixels to be displayed on the display 950. For example, if the display 950 is configured to include 640×480 pixels, the display buffer 940 may include 640×480 storage locations storing pixel color and intensity information, such as red, green, and blue pixel values, or other color values. The display buffer 940 may store the final pixel values for each of the pixels processed by the GPU 930. The display 950 may retrieve the final pixel values from the display buffer 940 and display the final image based on the pixel values stored in the display buffer 940. In some examples, the display buffer 940 may be a cache memory.

The user interface unit 910 be configured as a unit with which a user may interact with or otherwise interface to communicate with other units of the device 905, such as the CPU 915. Examples of the user interface unit 910 include, but are not limited to, a trackball, a mouse, a keyboard, and other types of input devices. The user interface unit 910 may also be, or include, a touch screen and the touch screen may be incorporated as part of the display 950.

The system memory 945 may include one or more computer-readable storage media. Examples of the system memory 945 include, but are not limited to, a RAM, static RAM (SRAM), dynamic RAM (DRAM), a ROM, an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. The system memory 940 may store program modules and instructions that are accessible for execution by the CPU 915. Additionally, the system memory 945 may store user applications and application surface data associated with the applications. The system memory 945 may, in some examples, store information for use by and information generated by other components of the device 905. For example, the system memory 945 may act as a device memory for the GPU 930 and may store data to be operated on by the GPU 930, as well as data resulting from operations performed by the GPU 930.

In some examples, the system memory 945 may include instructions that cause the CPU 915 or the GPU 930 to perform the functions attributed to the CPU 915 or the GPU 930 in aspects of the present disclosure. The system memory 945 may, in some examples, be considered as a non-transitory storage medium. The term “non-transitory” should not be interpreted to mean that the system memory 945 is non-movable. As one example, the system memory 945 may be removed from the device 905 and moved to another device. As another example, a system memory substantially similar to the system memory 945 may be inserted into the device 905. In some examples, a non-transitory storage medium may store data that can, over time, change (e.g., in RAM).

The system memory 945 may store the GPU driver 925 and compiler, a GPU program, and a locally-compiled GPU program. The GPU driver 925 may represent a computer program or executable code that provides an interface to access the GPU 930. The CPU 915 may execute the GPU driver 925 or portions thereof to interface with the GPU 930 and, for this reason, the GPU driver 925 is shown in the example of FIG. 9 within the CPU 915. The GPU driver 925 may be accessible to programs or other executables executed by the CPU 915, including the GPU program stored in the system memory 945. Thus, when one of the software applications executing on the CPU 945 needs graphics processing, the CPU 915 may provide graphics commands and graphics data to the GPU 930 for rendering to the display 950 (e.g., via the GPU driver 925).

In some examples, the GPU program may include code written in a high level (HL) programming language, e.g., using an application programming interface (API). Examples of APIs include Open Graphics Library (“OpenGL”), DirectX. Render-Man, WebGL, or any other public or proprietary standard graphics API. The instructions may also conform to so-called heterogeneous computing libraries, such as Open-Computing Language (“OpenCL”), DirectCompute, etc. In general, an API may include a determined, standardized set of commands that are executed by associated hardware. API commands allow a user to instruct hardware components of the GPU 930 to execute commands without user knowledge as to the specifics of the hardware components. To process the graphics rendering instructions, the CPU 915 may issue one or more rendering commands to the GPU 930 (e.g., through the GPU driver 925) to cause the GPU 930 to perform some or all of the rendering of the graphics data. In some examples, the graphics data to be rendered may include a list of graphics primitives (e.g., points, lines, triangles, quadrilaterals, etc.).

In the example of FIG. 9, the compiler may receive the GPU program from the CPU 915 when executing HL code that includes the GPU program. That is, a software application being executed by the CPU 915 may invoke the GPU driver 925 (e.g., via a graphics API) to issue one or more commands to the GPU 930 for rendering one or more graphics primitives into displayable graphics images. The compiler may compile the GPU program to generate the locally-compiled GPU program that conforms to a low-level (LL) programming language. The compiler may then output the locally-compiled GPU program that includes the LL instructions. In some examples, the LL instructions may be provided to the GPU 930 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), the GPU driver 925 may formulate one or more commands that specify one or more operations for the GPU 930 to perform to render the primitive. When the GPU 930 receives a command from the CPU 915, it may decode the command and configure one or more processing elements to perform the specified operation and may output the rendered data to the display buffer 940.

The GPU 930 may receive the locally-compiled GPU program, and then, in some instances, the GPU 930 renders one or more images and outputs the rendered images to the display buffer 940. For example, the GPU 930 may generate a number of primitives to be displayed at the display 950. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by the GPU 930 for display as an image (or frame in the context of video data) via the display 950. The GPU 930 may transform primitives and other attributes (e.g., that define a color, texture, lighting, camera configuration, or other aspect) of the primitives into a so-called “world space” by applying one or more model transforms (which may also be specified in the state data). Once transformed, the GPU 930 may apply a view transform for the active camera (which again may also be specified in the state data defining the camera) to transform the coordinates of the primitives and lights into the camera or eye space. The GPU 930 may also perform vertex shading to render the appearance of the primitives in view of any active lights. The GPU 930 may perform vertex shading in one or more of the above model, world, or view space.

Once the primitives are shaded, the GPU 930 may perform projections to project the image into a canonical view volume. After transforming the model from the eye space to the canonical view volume, the GPU 930 may perform clipping to remove any primitives that do not at least partially reside within the canonical view volume. That is, the GPU 930 may remove any primitives that are not within the frame of the camera. The GPU 930 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, the GPU 930 may then rasterize the primitives. Generally, rasterization may refer to the task of taking an image described in a vector graphics format and converting it to a raster image (e.g., a pixelated image) for output on a video display or for storage in a bitmap file format.

The GPU 930 may include a dedicated fast bin buffer (e.g., a fast memory buffer, such as general memory (GMEM), which may be referred to by the GPU memory 935). A rendering surface may be divided into bins. In some cases, the bin size is determined by format (e.g., pixel color and depth information) and render target resolution divided by the total amount of GMEM. The number of bins may vary based on the device 905 hardware, target resolution size, and target display format. A rendering pass may draw (e.g., render, write, etc.) pixels into GMEM (e.g., with a high bandwidth that matches the capabilities of the GPU). The GPU 930 may then resolve the GMEM (e.g., burst write blended pixel values from the GMEM, as a single layer, to the display buffer 940 or a frame buffer in the system memory 945). Such may be referred to as bin-based or tile-based rendering. When all bins are complete, the driver may swap buffers and start the binning process again for a next frame.

For example, the GPU 930 may implement a tile-based architecture that renders an image or rendering target by breaking the image into multiple portions, referred to as tiles or bins. The bins may be sized based on the size of the GPU memory 935 (e.g., which may alternatively be referred to herein as GMEM or a cache), the resolution of the display 950, the color or Z precision of the render target, etc. When implementing tile-based rendering, the GPU 930 may perform a binning pass and one or more rendering passes. For example, with respect to the binning pass, the GPU 930 may process an entire image and sort rasterized primitives into bins.

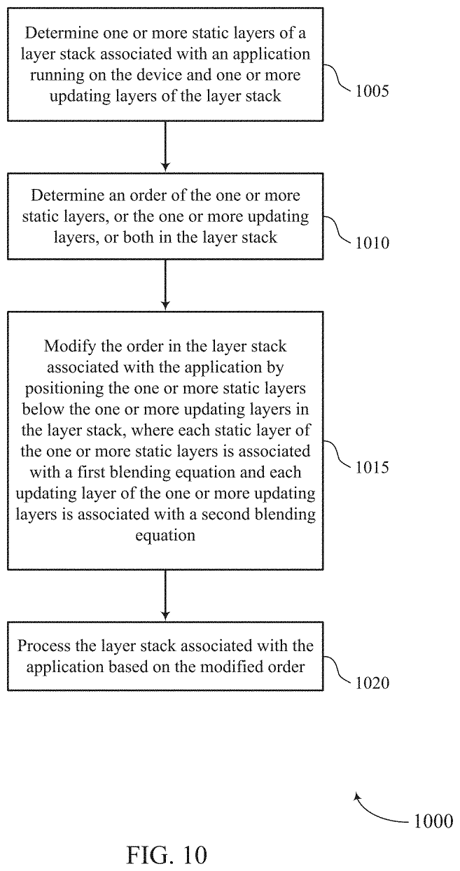

FIG. 10 shows a flowchart illustrating a method 1000 that supports display hardware enhancement for inline overlay caching in accordance with aspects of the present disclosure. The operations of method 1000 may be implemented by a device or its components as described herein. For example, the operations of method 1000 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1005, the device may determine one or more static layers of a layer stack associated with an application running on the device and one or more updating layers of the layer stack. The application may be a multimedia-based application that can receive (e.g., download, stream, broadcast) from a server, a database or another device, or transmit (e.g., upload) multimedia data to the server, the database, or to the other device. The operations of 1005 may be performed according to the methods described herein. In some examples, aspects of the operations of 1005 may be performed by a layer component as described with reference to FIGS. 5 through 8.

At 1010, the device may determine an order of the one or more static layers, or the one or more updating layers, or both in the layer stack. The operations of 1010 may be performed according to the methods described herein. In some examples, aspects of the operations of 1010 may be performed by an order component as described with reference to FIGS. 5 through 8.

At 1015, the device may modify the order in the layer stack associated with the application by positioning the one or more static layers below the one or more updating layers in the layer stack, where each static layer of the one or more static layers is associated with a first blending equation and each updating layer of the one or more updating layers is associated with a second blending equation. The operations of 1015 may be performed according to the methods described herein. In some examples, aspects of the operations of 1015 may be performed by an order component as described with reference to FIGS. 5 through 8.

At 1020, the device may process the layer stack associated with the application based on the modified order. The operations of 1020 may be performed according to the methods described herein. In some examples, aspects of the operations of 1020 may be performed by a stack component as described with reference to FIGS. 5 through 8.

The methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for image processing at a device, comprising:
determining one or more static layers of a layer stack associated with an application running on the device and one or more updating layers of the layer stack;
determining an order of the one or more static layers, or the one or more updating layers, or both in the layer stack;
modifying the order in the layer stack associated with the application by positioning the one or more static layers below the one or more updating layers in the layer stack, wherein each static layer of the one or more static layers is associated with a first blending equation and each updating layer of the one or more updating layers is associated with a second blending equation that is an inverse blending equation of the first blending equation; and
processing the layer stack associated with the application based at least in part on the modified order.

2. The method of claim 1, further comprising:
determining a cascade of blending stages associated with the one or more static layers, or the one or more updating layers, or both, wherein processing the layer stack associated with the application comprises:
processing, over the cascade of blending stages, the one or more static layers, or the one or more updating layers, or both according to one or more of the first blending equation or the second blending equation.

3. The method of claim 1, further comprising:
storing the one or more static layers in a cache memory of the device,
wherein processing the layer stack associated with the application is based at least in part on storing the one or more static layers in the cache memory of the device.

4. The method of claim 1, further comprising:
determining an ending static layer of the one or more static layers;
determining a blending stage of a cascade of blending stages associated with the one or more static layers, or the one or more updating layers, or both, wherein the blending stage comprises blending the ending static layer according to the first blending equation; and
storing the ending static layer of the one or more static layers in a cache memory of the device based at least in part on the blending stage of the cascade of blending stages.

5. The method of claim 1, wherein modifying the order in the layer stack comprises:
positioning the one or more static layers of the layer stack in a lower portion of the layer stack; and
maintaining, based at least in part on positioning the one or more static layers of the layer stack in the lower portion of the layer stack, one or more blending parameters associated with the one or more static layers and the first blending equation.

6. The method of claim 1, wherein processing the layer stack comprises:
processing, over one or more blending stages of a cascade of blending stages, the one or more static layers of the layer stack based at least in part on the first blending equation,
wherein the first blending equation comprises one or more blending parameters.

7. The method of claim 1, wherein processing the layer stack comprises:
processing, over one or more blending stages of a cascade of blending stages, the one or more updating layers based at least in part on the second blending equation,
wherein the second blending equation comprises one or more blending parameters.

8. (canceled)

9. The method of claim 1, wherein processing the layer stack comprises:
blending, over one or more blending stages of a cascade of blending stages, the one or more static layers and the one or more updating layers of the layer stack; and
providing, over the one or more blending stages of the cascade of blending stages, surface data associated with the layer stack.

10. The method of claim 9, wherein providing the surface data comprises:
storing the surface data at each blending stage of the cascade of blending stages in a cache memory of the device.

11. The method of claim 9, wherein providing the surface data comprises:
forwarding the surface data from one blending stage to a subsequent blending stage of the cascade of blending stages.

12. The method of claim 1, wherein modifying the order in the layer stack comprises:
determining a displacement of one or more updating layers of the one or more updating layers based at least in part on the modified order;
inverting a position of the displaced one or more updating layers in the layer stack; and
positioning the displaced one or more updating layers between the one or more static layers and one or more remaining updating layers of the one or more updating layers.

13. The method of claim 12, wherein processing the layer stack comprises:
processing the one or more static layers based at least in part on the first blending equation, wherein the first blending equation is associated with one or more blending parameters;
processing the displaced one or more updating layers based at least in part on the second blending equation, wherein the second blending equation comprises the one or more blending parameters; and
processing the one or more remaining updating layers based at least in part on the first blending equation.

14. The method of claim 12, wherein the one or more remaining updating layers of the one or more updating layers correspond to the order in the layer stack.

15. An apparatus for image processing, comprising:
a processor,
memory coupled with the processor;
and instructions stored in the memory and executable by the processor to cause the apparatus to:
determine one or more static layers of a layer stack associated with an application running on the apparatus and one or more updating layers of the layer stack;
determine an order of the one or more static layers, or the one or more updating layers, or both in the layer stack;
modify the order in the layer stack associated with the application by positioning the one or more static layers below the one or more updating layers in the layer stack, wherein each static layer of the one or more static layers is associated with a first blending equation and each updating layer of the one or more updating layers is associated with a second blending equation that is an inverse blending equation of the first blending equation; and
process the layer stack associated with the application based at least in part on the modified order.

16. The apparatus of claim 15, wherein the instructions are executable by the processor to cause the apparatus to:
determine a cascade of blending stages associated with the one or more static layers, or the one or more updating layers, or both, wherein the instructions to process the layer stack associated with the application are further executable by the processor to cause the apparatus to:
process, over the cascade of blending stages, the one or more static layers, or the one or more updating layers, or both according to one or more of the first blending equation or the second blending equation.

17. The apparatus of claim 15, wherein the instructions are executable by the processor to cause the apparatus to:
store the one or more static layers in a cache memory of the apparatus,
wherein the instructions to process the layer stack associated with the application are executable by the processor based at least in part on storing the one or more static layers in the cache memory of the apparatus.

18. The apparatus of claim 15, wherein the instructions are executable by the processor to cause the apparatus to:
determine an ending static layer of the one or more static layers;
determine a blending stage of a cascade of blending stages associated with the one or more static layers, or the one or more updating layers, or both, wherein the blending stage comprises blending the ending static layer according to the first blending equation; and
store the ending static layer of the one or more static layers in a cache memory of the apparatus based at least in part on the blending stage of the cascade of blending stages.

19. The apparatus of claim 15, wherein the instructions to modify the order in the layer stack are executable by the processor to cause the apparatus to:
position the one or more static layers of the layer stack in a lower portion of the layer stack; and
maintain, based at least in part on positioning the one or more static layers of the layer stack in the lower portion of the layer stack, one or more blending parameters associated with the one or more static layers and the first blending equation.

20. An apparatus for image processing, comprising:
means for determining one or more static layers of a layer stack associated with an application running on the apparatus and one or more updating layers of the layer stack;
means for determining an order of the one or more static layers, or the one or more updating layers, or both in the layer stack;
means for modifying the order in the layer stack associated with the application by positioning the one or more static layers below the one or more updating layers in the layer stack, wherein each static layer of the one or more static layers is associated with a first blending equation and each updating layer of the one or more updating layers is associated with a second blending equation that is an inverse blending equation of the first blending equation; and
means for processing the layer stack associated with the application based at least in part on the modified order.

21. The apparatus of claim 15, wherein the instructions to process the layer stack are executable by the processor to cause the apparatus to:
process, over one or more blending stages of a cascade of blending stages, the one or more static layers of the layer stack based at least in part on the first blending equation,
wherein the first blending equation comprises one or more blending parameters.
